(19) United States
(12) Patent Application Publication
(10) Pub. No.: US 2002/0163144 A1
(43) Pub. Date: Nov. 7, 2002

(54) Skateboard training device

(76) Inventor: Jonathon Guerra, San Francisco, CA (US)

Correspondence Address: HANCOCK & ESTABROOK, LLP, 1500 MONY Tower I, PO Box 4976, Syracuse, NY, 13221-4976, US

(21) Appl. No.: 10/096,719

(22) Filed: Mar. 12, 2002

Related U.S. Application Data
(60) Provisional application No. 60/274,158, filed on Mar. 9, 2001.

(51) Int. Cl. B62M 1/00; A63C 1/00

(52) U.S. Cl. 280/11.27; 280/87.042

(57) ABSTRACT

The device of the present invention comprises an elongated body intended to be interconnected to a the bottom surface of a skateboard, and extending transverse to the longitudinal axis of the board. In use, front and rear units of the device would be mounted in place of the skateboard's front and rear wheel and truck assemblies. The same openings that are used to interconnect a wheel truck to the board can be used to interconnect the training device of the present invention, thereby eliminating the need for the user of the device to drill new openings into the board. The body is shaped to simulate the height, width, and rocking motion of standard skateboard wheels by comprising a substantially flat lower (ground contacting) edge and an arcuate shaped transverse cross-section which permits it to rock about its longitudinal axis.

### CROSS-REFERENCE TO RELATED APPLICATION

The present application claims priority to U.S. Provisional Application, Serial No. 60/274,158, filed Mar. 9, 2001.

### BACKGROUND OF THE INVENTION

1. Field of Invention

The present invention relates generally to skateboards, and more particularly to a skateboard training device for practicing tricks and other maneuvers.

2. Description of Prior Art

Skateboarders are continuously developing trick maneuvers and aerobatics in the air with their skateboards. Practicing tricks and aerobatics on a skateboard often results in injuries to the user due to the instability of and motion created by the wheels which require balance beyond that required for simply riding the skateboard in a straightforward manner. If a rider wants to learn tricks and other maneuvers on a skateboard without risking serious injury perpetuated by the wheels, removal of the wheel trucks is necessary. However, for the learning to be effective, the rider should become accustomed to the height, width, and rocking motion of the wheels. Currently, no devices simulating these characteristics other than the wheels themselves are known.

3. Objects and Advantages

It is therefore a principal object and advantage of the present invention to provide a skateboard training device which simulates the height, width, and rocking motion of standard skateboard wheels.

It is an additional object and advantage of the present invention to provide a device which permits a skateboard rider to practice trick maneuvers without the rolling effect of and balance required by the wheels.

It is a further object and advantage of the present invention to provide a device which minimizes the risk of injuries that typically occur when practicing tricks on a standard skateboard.

Other objects and advantages of the present invention will in part be obvious, and in part appear hereinafter.

### SUMMARY OF THE INVENTION

In accordance with the foregoing objects and advantages, the device of the present invention comprises an elongated body intended to be interconnected to a the bottom surface of a skateboard, and extending transverse to the longitudinal axis of the board. In use, front and rear units of the device would be mounted in place of the skateboard's front and rear wheel and truck assemblies. The same openings that are used to interconnect a wheel truck to the board can be used to interconnect the training device of the present invention, thereby eliminating the need for the user of the device to drill new openings into the board. The body is shaped to simulate the height, width, and rocking motion of standard skateboard wheels by comprising a substantially flat lower (ground contacting) edge and an arcuate shaped transverse cross-section which permits it to rock about its longitudinal axis. The device is preferably composed of a rubber, plastic, or equivalent material (or combination of materials) to more closely simulate the resilient feel of the rubber wheels commonly used on skateboards. The dimensions of the device in terms of length, width, and thickness can vary depending on the user's type of board and his/her type of wheel and truck assemblies typically used, among other factors.

### BRIEF DESCRIPTION OF THE DRAWINGS

FIG. 1 is a perspective view of the skateboard training device of the present invention;

FIG. 2 is a top plan view thereof;

FIG. 3 is a front elevation view thereof;

FIG. 4 is a side elevation view thereof;

FIG. 5 is a bottom plan view thereof;

FIG. 6 is an exploded perspective view of the present invention shown in spaced relation to a skateboard; and

FIG. 7 is a side elevation view of the present invention attached to the bottom surface of a skateboard.

### DETAILED DESCRIPTION

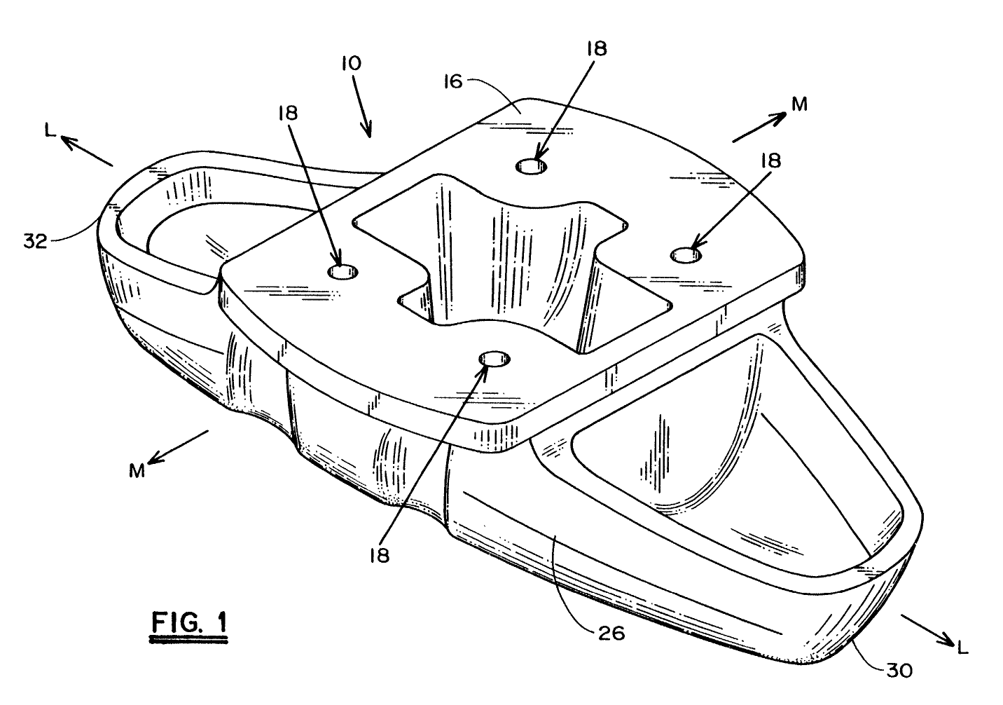

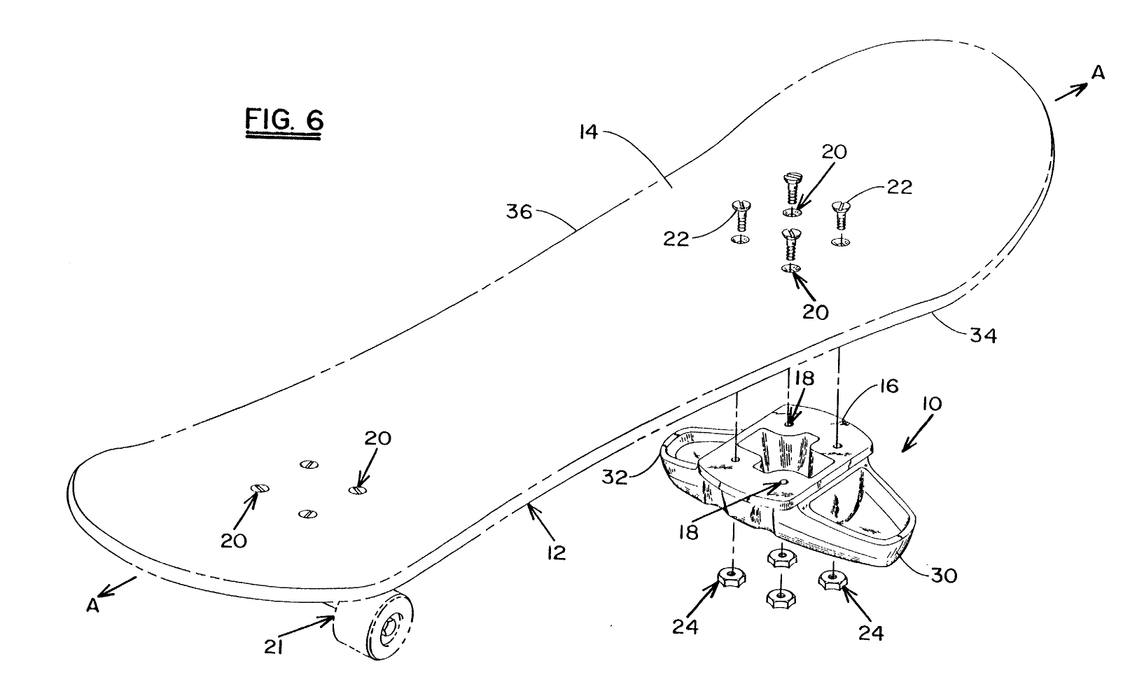

Referring now to the drawings in which like reference numerals refer to like parts throughout, there is seen in FIGS. 1-7 a skateboard training, device designated generally by reference numeral 10, which extends along a longitudinal axis L-L and is symmetrical about its midline, transverse axis M-M. Device 10 is intended to be interconnected to the bottom surface 12 of a standard skateboard 14 (it should be understood that the present invention could be effectively used to train a user on a variety of board types and a variety of wheel and truck assemblies, and that board 14 is simply described and shown as a generic board for reasons of simplicity and in compliance with the inventor's best mode known to practice th invention). Board 14 extends along a longitudinal axis A-A, and when device 10 is interconnected thereto, its longitudinal axis L-L extends transverse to the board's longitudinal axis A-A.

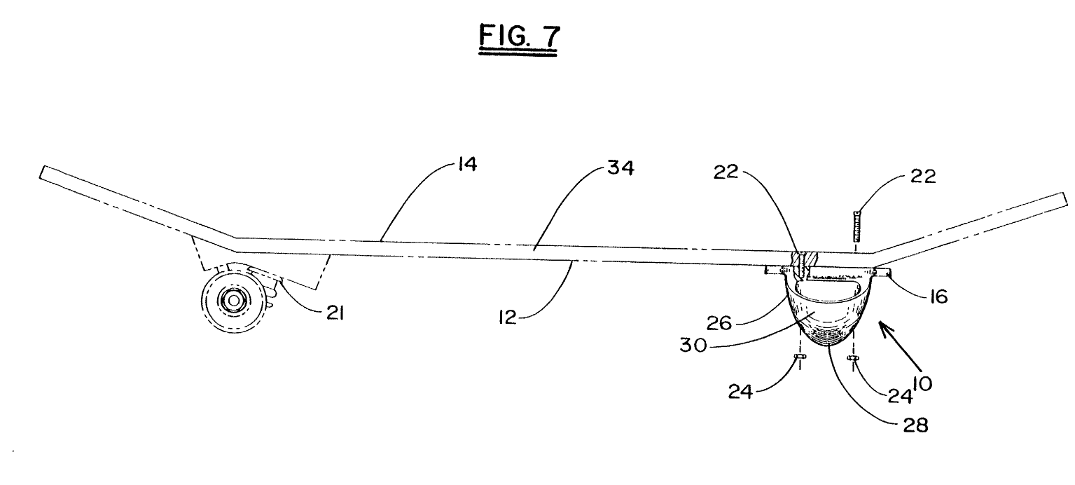

With reference to FIGS. 1-5, device 10 comprises a mounting portion 16 that is substantially planar and includes a set of openings 18 formed therethrough for interconnecting device 10 to bottom surface 12 of board 14 (although four openings are illustrated, two openings would facilitate a secure connection). Openings 18 are positioned to axially align with the pre-drilled mounting holes 20 typically formed through board 14 for securing wheel truck assemblies 21 (See FIGS. 6 and 7) thereto. Nut and bolt combinations 22, 24, respectively, are inserted though axially aligned pairs of openings 18 and 20 to secure the interconnection of device 10 to board 14.

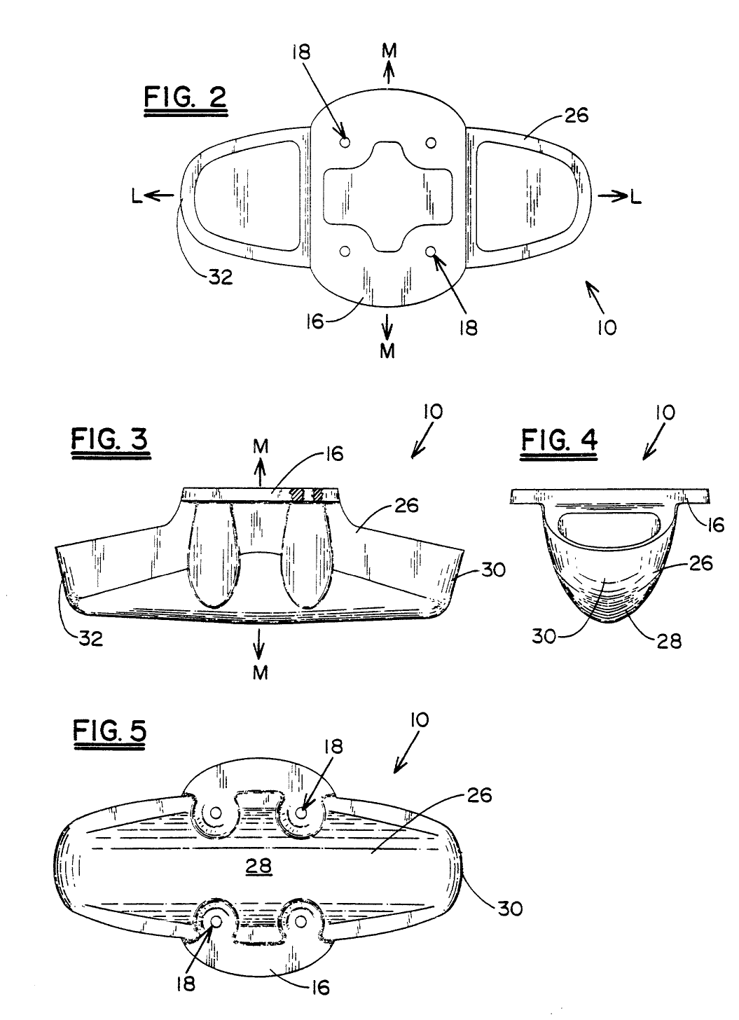

Device 10 further comprises a body portion 26 extending from mounting portion 16 and which extends along axis L-L. The bottom (ground contacting) surface 28 of body portion 26 is slightly curved along axis L-L to permit limited rocking of skateboard 12 about its midline transverse axis M-M, thereby simulating the slight pivoting nature of skateboard wheels about this same axis. As seen in FIG. 2, body portion 26 is arcuate in cross-sectional planes transverse to longitudinal axis L-L, with the vertex of the arc being lower surface 28 (i.e., lower surface 28 is the point at which the sides of the arc meet), thereby permitting pivotal movement about axis L-L and simulating the rolling effect of a wheel. The height of device 10 closely approximates the combined height of standard skateboard wheel and truck assemblies.

When mounted to skateboard 14, mounting portion 16 is positioned in contacting relation to lower surface 12, and body portion 26 extends transverse to longitudinal axis A-A. The sides 30, 32 of device 10 are positioned in close vertical alignment with corresponding side edges 34, 36, respectively, of board 14 (the closeness of the alignment being a function of the length of body portion 26 which can vary, as described below). With front and rear devices 10 mounted in place of the front and rear wheel truck assemblies 21, a stable, non-rolling, but otherwise wheel simulating assembly is formed, thereby permitting a user of device 10 to practice tricks on skateboard 14 without incurring the risks associated therewith due to the presence of wheels.

The dimensions of device 10 may vary depending on the desired effect, i.e., the degree of roll desired in a given direction, but will generally correspond to the dimensions of skateboard 12 and the wheel assemblies which device 10 replicates. When two devices 10 are installed on skateboard 12, a user may practice trick maneuvers without rolling of skateboard 12 indoors or outside and without the rolling motion caused by wheels, thus minimizing the potential for injury and allowing indoor or outdoor use.

Device 10 maybe composed of rubber, plastic, or any combination thereof, with the intent being to provide a durable training device that simulates the resilient feel of a skateboard wheel. Fabrication of device 10 can be from injection molding, casting, or other suitable manufacturing process. Device 10 may also be produced in a wide variety of colors, textures, and finishes to add to its aesthetic appeal.

What is claimed is:

1. A training device for mounting to the bottom surface of a standard skateboard, said training device comprising:
a. a mounting portion; and
b. a body portion extending from said mounting portion along a longitudinal axis and including a midline that is transverse to said longitudinal axis, a lower edge that is rounded along said longitudinal axis and symmetrically about said midline, and an arc shaped cross-section in planes transverse to said longitudinal axis with said lower edge forming the vertex of said arc.

2. The training device of claim 1, wherein said mounting portion includes at least two openings formed therethrough.

3. A skateboard training device in combination with a skateboard comprising a deck that extends along a first longitudinal axis, first and second sets of at least two openings formed through said deck for mounting first and second wheel truck assemblies thereto, respectively, said training device comprising:
a. a mounting portion having at least two openings formed therethrough which are axially aligned with respective ones of said first set of openings formed through said deck;
b. a body portion extending from said mounting portion along a second longitudinal axis and including a midline that is transverse to said second longitudinal axis, a lower edge that is rounded along said second longitudinal axis and symmetrically about said midline, and an arc shaped cross-section in planes transverse to said second longitudinal axis with said lower edge forming the vertex of said arc, wherein said first longitudinal axis is transverse to said second longitudinal axis; and
c. fasteners for interconnecting said device to said skateboard.

4. The skateboard training device and skateboard combination of claim 3, wherein said fasteners comprise a bolt that extends through one of each of said at least two openings formed through said mounting portion and said deck, and a nut.
